(19) United States
(12) Patent Application Publication
(10) Pub. No.: US 2004/0157523 A1
(43) Pub. Date: Aug. 12, 2004

(54) Headliner

(76) Inventors: Bernd Glunk, (US); Gerhard Koeck, (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/706,616

(22) Filed: Nov. 12, 2003

(30) Foreign Application Priority Data
Nov. 12, 2002 (DE) 20217447.6

(51) Int. Cl. B32B 5/18; B32B 5/24; B32B 27/12; B32B 9/00

(52) U.S. Cl. 442/370; 428/318.4; 428/319.3; 442/394

(57) ABSTRACT

A roof liner includes a core layer, a reinforcement layer arranged on at least one side of the core layer, and a decorative layer facing a passenger compartment. The reinforcement layer is formed from at least one plastic matrix and fibres. The core layer is formed from a foam material. The foam material and the plastic matrix present at least one polyolefin. The polyolefin of the foam material is polypropylene and the fibres are arranged non-directionally in the plastic matrix.

Such a roof liner is known from the practice and serves to attach to the body of a vehicle, in order to cover a corresponding roof of the vehicle body in the direction of the passenger compartment and simultaneously to serve as a component holder. As a rule, such a roof liner is formed from at least one core layer, a reinforcement layer arranged on at least one side of this core layer and a decorative layer facing a passenger compartment. For the core layer, a foamed plastic material, for example, is used, by means of which there is a reduction in the weight while simultaneously maintaining a corresponding stiffness of the roof liner. The reinforcement layer is constructed of fibres and a plastic matrix, for example.

The object of the invention is to improve such a roof liner to the effect that, while maintaining its stiffness, it is lighter, displays good thermal and climate behaviour and is simultaneously at least partially recyclable.

This object is solved by means of the features of claim 1.

According to the invention, at least one polyolefin is used for the foam material of the core layer and plastic matrix of the reinforcement layer, in order to achieve a light-weight construction of the roof liner. In order to form the finished roof liner so that it is even lighter, polypropylene is used at the same time for the foam material as a polyolefin. This furthermore distinguishes itself because of good thermal and climate behaviour. In order to guarantee the rigidity or stiffness of the roof liner in this connection in spite of the light-weight construction, fibres are arranged in the plastic matrix non-directionally. Because of the non-directional arrangement of the fibres, better plasticity, in comparison to uni-directionally arranged fibres, simultaneously results for the roof liner, in order that the roof liner can be correspondingly adapted to the vehicle body.

In this connection, polypropylene or polyethylene or a mixture of the two can preferably be the polyolefin for the plastic matrix.

A further improvement of the thermal and climate behaviour, as well as lighter construction, results by stretching the polypropylene of the foam material uni-directionally or bi-directionally. An appropriate stretch ratio in this regard can be between 4 and 50 and preferably between 6 and 40.

To improve the recycling ability of the roof liner and particularly of the corresponding reinforcement layers, the fibres can be natural fibres of jute, sisal or the like.

For at least partial prefabrication of the reinforcement layer, the fibres can be formed as a fibre mat with the polyolefin(s) as a powder or fibrous additive as a so-called pre-preg.

For a further increase in the rigidity or stiffness of the reinforcement layer, it can also include polyester, polyester fibres and/or a bonding agent.

For easier manufacture of the reinforcement layer, the polyester can be added, in this connection, as a polyester mat of the reinforcement layer. At the same time, the polyester mat can form a surface of the reinforcement layer.

Precisely in connection with the tangled positioning of the fibres, it has become apparent that the ratio of fibres in a reinforcement layer is optimal when it is between 15 and 40 percent by weight and preferably between 20 and 35 percent by weight. The remaining percent by weight consists of the plastic matrix, polyester and bonding agent.

The manufacture of a corresponding roof liner according to the invention can be further simplified by not applying any separate adhesive, for example, to one side of the reinforcement layer or one side of the decorative layer or both corresponding sides. Corresponding application devices, such as spraying devices, spreading rolls and the like are then not necessary. Instead, the decorative layer itself and/or a sandwich made of a core layer and reinforcement layer can be warmed before the shaping of the roof liner without corresponding application of a separate adhesive, and both are subsequently brought into contact. By heating the sandwich/decorative layer, a corresponding surface is at least partially softened, so that a joining of the decorative layer and sandwich can result via this softened surface layer and/or an additional softening of a corresponding surface of the decorative layer and subsequent hardening of these layers.

In order to improve the joining between the decorative layer and sandwich in this connection, the decorative layer can present an adhesive, particularly as an adhesive fibre mat. This is softened by the contact heat of the heated sandwich at least so much that a joining is securely produced between the decorative layer and sandwich. In this way, the joining of the sandwich and decorative layer is essentially done “dry”, which means without application of an additional adhesive.

There is also the possibility that instead of the natural fibres, synthetic fibres can be used, and, in this connection, glass fibres, for example, for the fibres of the reinforcement layer.

Depending on the material of the fibres, the material of the corresponding plastic matrix can be selected, for example, in order to optimise the properties of the reinforcement layer. Combinations are conceivable, such as glass fibres with polyethylene and jute fibres with polypropylene. Naturally, other combinations are also possible.

With regard to the polyester or above-mentioned polyester mat, it is pointed out that, instead of polyester, other materials can also be contained in the reinforcement layer, such as polyethersulfone, which likewise can be added in the form of a mat.

In order to provide the roof liner with optionally necessary energy absorption elements, that is, so-called crash pads, during its manufacture and shaping, the roof liner can present integrated energy absorption elements, particularly during the shaping of the roof liner. This means that the energy absorption elements are not manually arranged on the roof liner and fastened there, but instead are, for example, placed into a corresponding mould for shaping the roof liner and, during the heating and shaping of the roof liner, attached to this roof liner at predetermined places with a predetermined orientation. As a result, it is possible for a shaping of the energy absorption elements to take place simultaneously.

In order to further simplify the manufacture of the roof liner according to the invention, there is the possibility of carrying out the application of the decorative layer and shaping of the roof liner in a one-step process. This can be done in the way that a corresponding decorative layer is allocated to one side of the sandwich and inserted into a corresponding tool with it for forming and subsequently joined to the sandwich during the shaping. It is likewise possible that, before applying the decorative layer, the sandwich is trimmed and then the decorative layer is applied, particularly with crimping.

In connection with the bonding agent added to the reinforcement layer, it is noted that this can be a thermoplastic emulsion, for example.

In the following, an advantageous embodiment of the invention is explained using the figures included with the drawing.

Shown are:

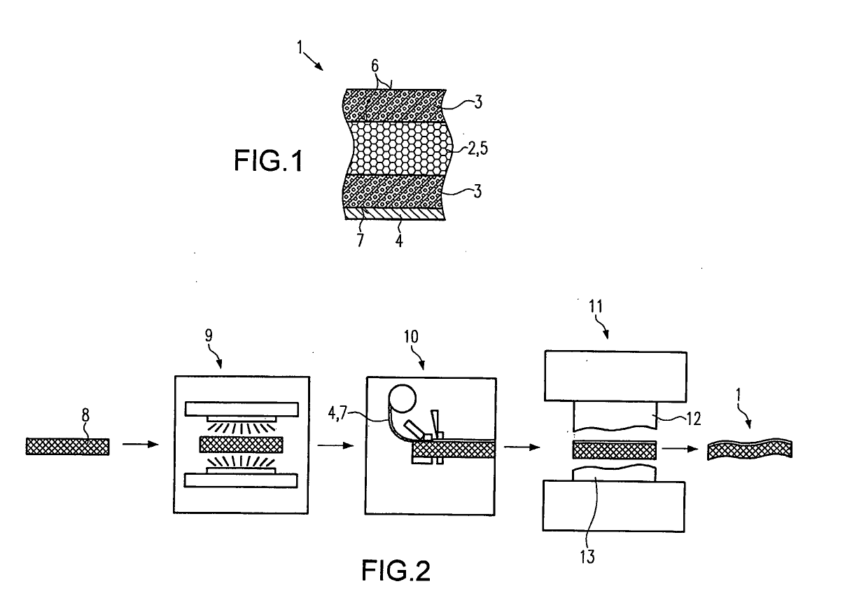

FIG. 1 a partially longitudinal section of a roof liner according to the invention and

FIG. 2 some steps for attaching a decorative layer to the roof liner in a one-step process.

In FIG. 1, a partially represented cross-section through a roof liner 1 according to the invention is depicted. This presents a central core layer 2 of a foam material 5. Reinforcement layers 3 are applied to both sides of the core layer 2. These can present a polyester mat 6 on one of their sides, for example. Furthermore, on a reinforcement layer 3, which faces a passenger compartment of a vehicle, a decorative layer 4 is applied. An adhesive fleece mat 7 is arranged on its upper side that faces the allocated reinforcement layer 3.

The foam material 5 of the core layer 2 is a polyolefin and, in particular, polypropylene. This presents a certain stretch ratio, which amounts to between 4 and 50 and preferably between 6 and 40. The reinforcement layers 3 present a plastic matrix with fibres. The plastic matrix is likewise formed by a polyolefin such as polypropylene and/or polyethylene. The fibres are arranged with tangled positioning, whereby both synthetic fibres, such as glass fibres, for example, and natural fibres, such as sisal, linen, hemp or the like, can be used. The fibres lie in the form of a fibre mat or a fibre fleece, to which the corresponding polyolefin is added as a powder or fibrous additive.

In addition to the polyolefin and fibres, the reinforcement layer in one embodiment furthermore contains polyester, optionally in fibre form, and/or a bonding agent. The bonding agent is a thermoplastic emulsion, for example.

The ratio of the fibres in the reinforcement layer is between 15 and 40 percent by weight and preferably between 25 and 35 percent by weight.

There is also the possibility that the corresponding polyester or the polyester fibres of the reinforcement layer are contained in the reinforcement layer in the form of a polyester mat, which means, for example, on the surface, see FIG. 1, or are arranged in its inside. For simplification, an energy absorption element, that is, a so-called crash pad, is not additionally depicted on the side of the roof liner 1 facing away from the decorative layer 4. Such an energy absorption element or series of energy absorption elements can be integrated in the vehicle body in the roof liner with the corresponding shaping of the roof liner for adaptation to the installation site, which means attached to the roof liner by heating, pressing and shaping and optionally self-shaped.

In FIG. 2, several process steps for the manufacture of a roof liner according to the invention are described, whereby these process steps particularly affect the attachment of the decorative layer 4 according to FIG. 1.

In this process, a corresponding sandwich 8 made of the core layer 2 with reinforcement layers 3 is fed into a heating device 9, which, for example, presents a contact heater or a radiation field. If the sandwich is sufficiently heated, particularly in the area of the outside reinforcement layers 3, in the decorative feed device 10, a corresponding decorative layer is fed, optionally with an adhesive fleece mat 7 provided on it. As a result of the heating in the heating device 9, it is possible, on the one hand, for the corresponding side of the appropriate reinforcement layer 3 facing the decorative layer to be sufficiently softened to produce a joining to the decorative layer after hardening and, on the other hand, the heat can be sufficient to activate the adhesive fleece and, through this, likewise to produce the joining to the decorative layer, in addition to the softened material of the reinforcement layer. Additionally or alternatively, the decorative layer can also be heated.

As a result, the heating in the heating device 9 serves not only to join the sandwich 8 to the decorative layer 10, but also to form the sandwich with the decorative layer via appropriate upper and lower tools 12, 13 in a subsequent shaping press 11 and to produce the joining to the decorative layer during the shaping. This one-step process for shaping and joining to the decorative layer makes process optimisation possible during the manufacture of the roof liner, whereby even sensitive material can be well processed by means of particularly appropriate settings in a small process window for the heating device 9. By using the foam material of polypropylene, manufactured with a particular stretch ratio, and acting together with the particular reinforcement layers with fibres in a tangled arrangement, an improvement in the thermal and climate behaviour of the roof liner also results, as well as a roof liner with relatively good recycling ability, particularly when natural fibres are used for the reinforcement layers.

The roof liner according to the invention is furthermore relatively light with a gram weight in the area of roughly 450 to 750 g/m². Despite this light-weight construction, the use of the appropriate materials and combination of the corresponding layers results in sufficient stiffness of the roof liner, which, as a rule, is larger than 9 N.

1. Roof liner (1) with a core layer (2), a reinforcement layer (3) arranged on at least one side of this core layer (2) and a decorative layer (4) facing a passenger compartment, whereby the reinforcement layer (3) is formed from at least one plastic matrix and fibres and the core layer (2) is formed from a foam material,
characterised in that
the foam material (5) and plastic matrix present at least one polyolefin, whereby the polyolefin of the foam material is polypropylene and the fibres are arranged non-directionally in the plastic matrix.

2. Roof liner according to claim 1,
characterised in that
the polyolefin of the plastic matrix is polypropylene and/or polyethylene.

3. Roof liner according to claim 1 or 2,
characterised in that
the polypropylene of the foam material presents a stretch ratio of between 4 and 50 and preferably between 6 and 40.

4. Roof liner according to one of the preceding claims,
characterised in that
the fibres are natural fibres of jute, sisal or the like.

5. Roof liner according to one of the preceding claims,
characterised in that
the fibres are formed as a fibre mat with the polyolefin as a powder or fibrous additive.

6. Roof liner according to one of the preceding claims,
characterised in that
the reinforcement layer (3) furthermore contains polyester fibres and/or a bonding agent.

7. Roof liner according to claim 6,
characterised in that
the polyester is added to the reinforcement layer (3) as a polyester mat.

8. Roof liner according to one of the preceding Claims,
characterised in that
the ratio of the fibrous portion of fibres in the reinforcement layer (3) is between 15 and 40 percent by weight or preferably between 20 and 35 percent by weight.

9. Roof liner according to one of the preceding claims,
characterised in that
before the shaping of the roof liner (1), without application of a separate adhesive, the decorative layer (4) itself and/or a sandwich (8) made of a core layer (2) and reinforcement layer (3) are warmed and both are subsequently in contact.

10. Roof liner according to one of the preceding Claims,
characterised in that
the decorative layer (4) presents an adhesive, particularly as an adhesive fleece mat (7).

11. Roof liner according to one of the preceding claims,
characterised in that
the fibres of the reinforcement layer (3) are glass fibres or other synthetically manufactured fibres.

12. Roof liner according to one of the preceding claims,
characterised in that
the roof liner (1) presents integrated energy absorption elements, particularly during the shaping of the roof liner.

13. Roof liner according to one of the preceding claims,
characterised in that
the application of the decorative layer (4) and the forming of the roof liner (1) are carried out in a one-step process.

14. Roof liner according to one of the preceding claims,
characterised in that
the bonding agent of the reinforcement layer is a thermoplastic emulsion.
